(19) United States
(12) Patent Application Publication
(10) Pub. No.: US 2019/0311744 A1
(43) Pub. Date: Oct. 10, 2019

(54) Comparing frame data to generate a textless version of a multimedia production

(71) Applicant: Deluxe One LLC, Burbank, CA (US)

(72) Inventor: Andrew Shenkler, Playa Vista, CA (US)

(21) Appl. No.: 16/377,860

(22) Filed: Apr. 8, 2019

Related U.S. Application Data
(60) Provisional application No. 62/654,294, filed on Apr. 6, 2018.

(51) Int. Cl. G11B 27/036; G06K 9/00; G11B 27/30; G11B 27/34

(52) U.S. Cl. CPC G11B 27/036; G11B 27/34; G11B 27/3081; G06K 9/00758

(57) ABSTRACT

A media frame alignment system aligns textless media clips with associated texted media frames in a multimedia production, such as film or video. Textless frames in a film clip are aligned with frames containing text (e.g., in the final version of a film) based on similar frame data. Masking may be applied to both the textless clip and to the texted frames to mask areas within the frames that differ, such as the text in the multimedia production and the associated areas in the textless clip. The frame data surrounding the masks can be analyzed and the frame data from the textless frames and from the texted frames in the multimedia production can be compared to determine matching frames. Once the textless frames are matched with texted frames in the multimedia production, an edit decision list (EDL) and/or master textless version may be created.

### CROSS REFERENCE TO RELATED APPLICATIONS

This application claims the benefit of priority pursuant to 35 U.S.C. § 119(e) of U.S. Provisional Application No. 62/654,294 filed 6 Apr. 2018 and entitled “Comparing frame data to generate a textless version of a multimedia production,” which is hereby incorporated herein by reference in its entirety.

### TECHNICAL FIELD

The technology described herein relates to aligning and inserting frames in a multimedia production, specifically, to aligning and inserting textless frames into a texted version to produce a textless master version.

### BACKGROUND

Films often have text titles throughout the film to relay different information to audiences. Film titles may include subtitles, captions, censor or rating cards, distributor logos, main titles, insert titles, and end titles. A need often arises to edit or remove some or all of the titles in a film, for example, during localization. For example, when a foreign version of a film is made, most titles must be replaced with foreign language titles. Currently, a film studio or post-production facility will send a texted version of a film (e.g., the original final edit or cut of the film for theatrical release) along with textless frames (i.e., raw video frames without titles, subtitles, captions, etc.) that are associated with the frames containing text in the texted version of the film to a media services company for processing. This allows the media processing company to manually line up the textless frames with the texted version and replace the texted frames in the texted version with the textless frames, so that foreign language titles, for example, can be inserted without overlaying existing titles.

The current process of manually aligning the textless frames to the texted version of the film requires a person to manually search for the texted frames and compare the textless frames to the texted version frame-by-frame to find a match and determine where to insert the textless frames. This process is labor-intensive and time consuming.

There is a need for a textless master copy to facilitate localization processes and an easier method of aligning frames to produce a textless master copy. Specifically, there is a need for an automated method of aligning textless frames with texted frames in a film to produce a textless master copy.

The information included in this Background section of the specification, including any references cited herein and any description or discussion thereof, is included for technical reference purposes only and is not to be regarded subject matter by which the scope of the invention as defined in the claims is to be bound.

### SUMMARY

A computer-implemented media frame alignment system comprises a storage device configured to ingest and store one or more media files thereon; and one or more processors configured with instructions to receive a texted version of a multimedia production and a textless media clip associated with the texted version of the multimedia production, wherein the texted version of the multimedia production comprises one or more texted frames and the textless media clip comprises one or more textless frames; mask text in the one or more texted frames; mask a same area in the one or more textless frames as the text in the one or more texted frames; analyze frame data surrounding the masks; compare the analyzed frame data between the one or more texted frames and the one or more textless frames to determine frames with similar frame data; and align the one or more textless frames with the one or more texted frames based on frames with similar frame data.

A method implemented on a computer system for aligning media frames, wherein one or more processors in the computer system is particularly configured to perform a number of processing steps including the following: receiving a texted version of a multimedia production and a textless media clip associated with the texted version of the multimedia production, wherein the texted version of the multimedia production comprises one or more texted frames and the textless media clip comprises one or more textless frames; masking text in the one or more texted frames; masking a same area as the text in the one or more texted frames in the one or more textless frames; analyzing frame data surrounding the masks; comparing the analyzed frame data between the one or more texted frames and the one or more textless frames to determine frames with similar frame data; and aligning the one or more textless frames with the one or more texted frames based on frames with similar frame data.

A non-transitory computer readable storage medium contains instructions for instantiating a special purpose computer to align media frames, wherein the instructions implement a computer process include the following steps: receiving a texted version of a multimedia production and a textless media clip associated with the texted version of the multimedia production, wherein the texted version of the multimedia production comprises one or more texted frames and the textless media clip comprises one or more textless frames; masking text in the one or more texted frames; masking a same area as the text in the one or more texted frames in the one or more textless frames; analyzing frame data surrounding the masks; comparing the analyzed frame data between the one or more texted frames and the one or more textless frames to determine frames with similar frame data; and aligning the one or more textless frames with the one or more texted frames based on frames with similar frame data.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments and implementations and illustrated in the accompanying drawings.

### BRIEF DESCRIPTION OF THE DRAWINGS

FIG. 1 is a flow chart illustrating a method of generating an EDL and/or a textless master copy based on comparison of textless frame data.

FIG. 2 is a flow chart illustrating a perceptual hash process as one method of analyzing frame data for the method of FIG. 1.

FIG. 3A is a picture diagram illustrating a method of masking titles in an original version of a film.

FIG. 3B is a picture diagram illustrating a method of masking the same areas in a film clip containing textless frames as masked in the film of FIG. 3A.

FIG. 3C is a picture diagram illustrating a method of analyzing and comparing frame data surrounding the masks for the film of FIG. 3A and the film clip of FIG. 3B.

FIG. 3D is a picture diagram illustrating a method of creating a textless master using textless film clips.

FIG. 4 is a schematic diagram of an exemplary computer system for processing, masking, analyzing frame data, and aligning textless frames with original titled frames as described herein.

### DETAILED DESCRIPTION

This disclosure is related to aligning textless media clips to associated texted media frames in a multimedia production, such as film or video. In several embodiments, textless frames in a clip of a multimedia production may be aligned with the original frames containing text in the multimedia production based on similar frame data. In one embodiment, masking may be applied to both the textless clip and to the texted frames in the multimedia production to mask areas within the frames that differ, such as the text in the multimedia production and the associated areas in the textless clip. Such masks allow for a more accurate comparison of frames to determine frames that match. After applying the masks, the frame data surrounding the masks can be analyzed and the frame data from the textless frames and from the texted frames in the multimedia production can be compared to determine matching frames. Once the textless frames are matched with texted frames in the multimedia production, an edit decision list (EDL) and/or master textless version may be created.

In many embodiments, once similar frame level data is identified between the textless frames in the multimedia production clip and the titled frames in the multimedia production, the frame locations for the textless frames may be determined. For example, the matching texted frames in the multimedia production may have frame numbers or timecode information such that matching textless frames to the texted multimedia frames allows for identification of the appropriate frame number or timecode location for each textless frame. Once the frame location for each textless frame is known, a digital specification, such as an EDL, may be created and/or the textless frames may replace the texted frames at the known frame locations in the multimedia production to produce a full version of the multimedia production with no text or titles, i.e., a textless master copy.

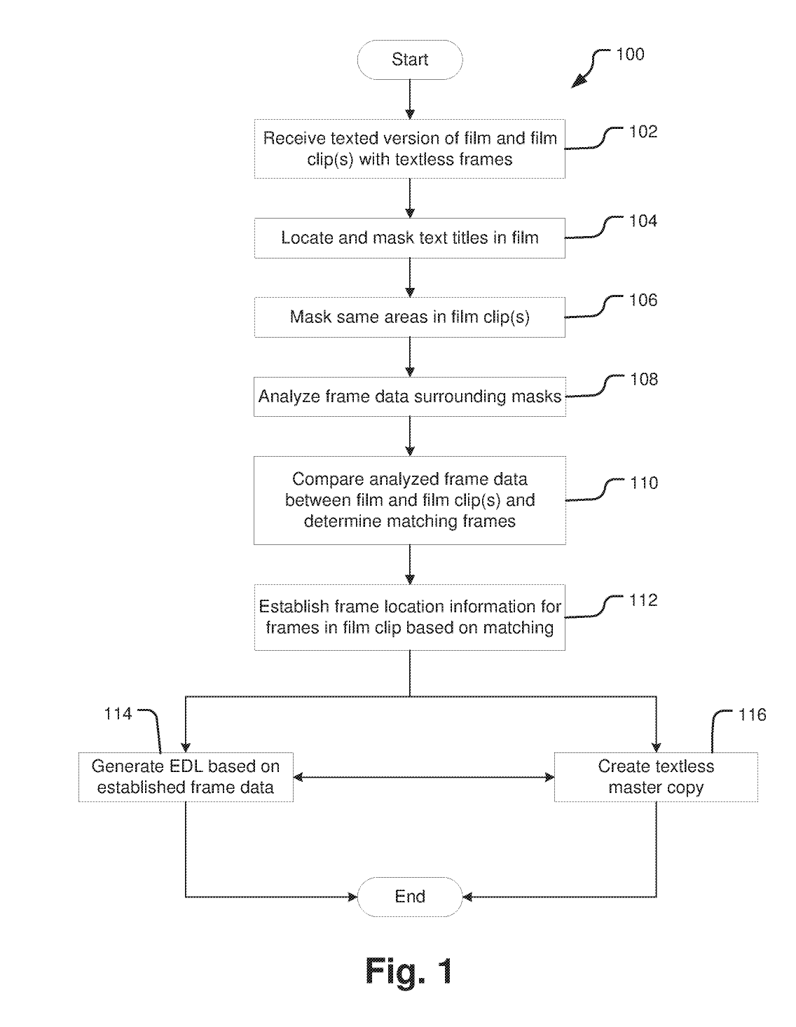

Turning now to the figures, a method of the present disclosure will be discussed in more detail. FIG. 1 is a flow chart illustrating a method of generating an EDL and/or textless master based on comparison of textless frame data. The method 100 begins with operation 102 and a texted version of a film and a film clip or clips with one or more textless frames are acquired. The one or more textless frames in the film clips may each be associated with one or more texted frames in the film. For example, the only difference between the textless frames in the film clips and the texted frames in the film may be the text overlay in the texted frames. Text in the texted frames may include for example, subtitles, captions, censor or rating cards, distributor logos, main titles, insert titles, end titles, or the like. All other frame data may be the same. As an example, a textless film clip may be comprised of frames that make up a single scene in the associated film, for example, an establishing shot of an old home. In the original texted film, the establishing shot may have text, for example, “My childhood home, 1953.” It may be desirable during a localization processes to translate such a subtitle into a foreign language for a foreign language version of the film. In order to insert the foreign language titles into the film, it may be necessary to first have a clean copy of the film with no text, so that the foreign language titles do not overlie existing titles. Thus, during localization processes, for example, textless film clips of the same scenes or frames that have text in the original film may be provided along with the texted version of the film to allow for creation of a textless version of the film.

After operation 102, the method 100 proceeds to operation 104 and the text titles in the original texted version of the film are located and masked or hidden. The text titles may be located based on timecode or metadata, and a matte may be used to mask portions of frames containing text. The mask may also be a bounding box that surrounds and overlays the text. It is contemplated that conventional masking techniques may be used. It is also contemplated that the mask may cover each letter separately or the entire text as a whole.

After operation 104, the method 100 proceeds to operation 106 and the same areas are masked in the textless frames of the film clip or clips as were masked in the texted frames to cover the titles at operation 104. Different methods are contemplated for masking the same areas in the textless frames. For example, a single mask from a group of texted frames with the same mask created at operation 104 may be used as a reference mask for all film clips. The same mask may be placed in the same position across all textless frames in the film clips. In another example, all masks created in the texted version of the film to cover text in different locations may be used. In this case, all masks may be overlayed in each texted frame of the film, and, likewise, all masks may be overlayed in each textless frame of the film clips. This process creates texted frames and textless frames with multiple masks in numerous locations in each frame, where the locations of all masks match across all frames. This example is only appropriate where there is limited text and thus a limited total mask are, as too much masked area will prevent accurate comparison of the remaining frame data, as discussed in further detail below.

After operation 106, the method 100 proceeds to operation 108 and the frame data surrounding the masks is analyzed. Many different methods of analyzing frame data are contemplated, including conventional methods. Various frame data may be used as the basis for the analysis, including, for example, images or metadata. In some embodiments, frame data analysis may involve perceptual hashing techniques, for example, where images surrounding the masks are used as the basis for the analysis. It is contemplated that this process may be performed by using known perceptual hash functions, e.g., imagehash (www.github.com/JohannesBuchner/imagehash), on the masked frames.

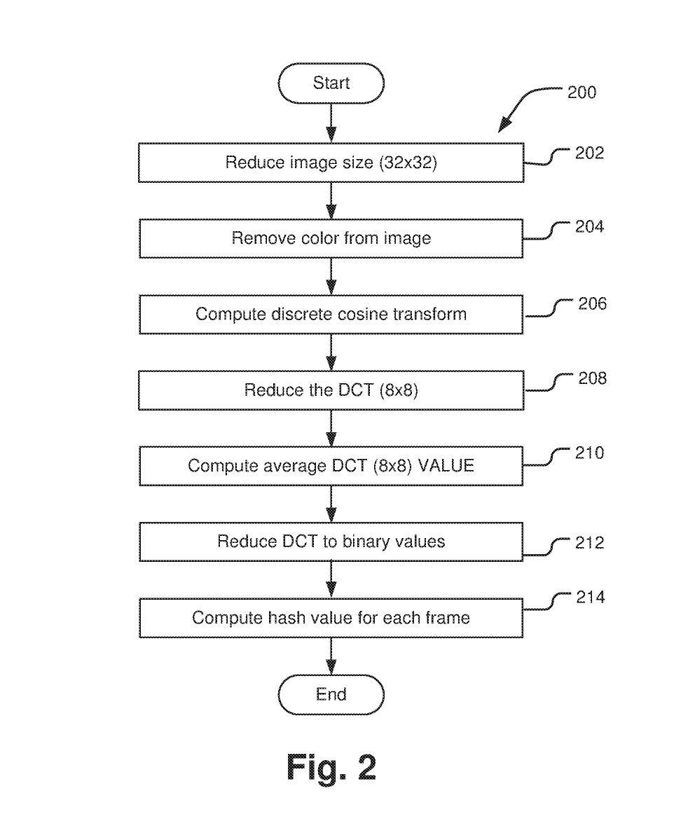

An exemplary perceptual hash process 200 is presented in FIG. 2. Perceptual hash algorithms describe a class of comparable hash functions. Features in the image are used to generate a distinct (but not unique) fingerprint, and these fingerprints are comparable. Perceptual hashes create a different numerical result as compared to traditional cryptographic hash functions. With cryptographic hashes, the hash values are random; identical data will generate the same result, but different data will create different results. Comparison of cryptographic hashes will only determine if the hashes are identical or different, and thus whether the data is identical or different. In contrast, perceptual hashes can be compared to provide a measure of similarity between the two data sets. Thus, in the context of video, for example, perceptual hashes of similar images, even if presented at different scales, with different aspect ratios, or with coloring differences (e.g., contrast, brightness, etc.), will still generate values indicating similar images.

A principle component of perceptual hash algorithm is a discrete cosine transform (DCT) which can be used in this context to mathematically translate the two dimensional picture information of an image into frequency values (i.e., representations of the frequency of color change, or color which changes rapidly from one pixel to another, within a sample area) that can be used for comparisons. With DCT transforms of pictures, high frequencies indicate detail, while low frequencies indicate structure. A large, detailed picture will therefore transform to a result with many high frequencies. In contrast, a very small picture lacks detail and thus is transformed to low frequencies. While the DCT computation can be run on highly detailed, pictures, for the purposes of comparison and identifying similarities in images, it has been found that the detail is not necessary and removal of the high frequency elements can reduce the processing requirements and increase the speed of the DCT algorithm.

Therefore, for the purposes of performing a perceptual hash of an image, it is desirable to first reduce the size of the image as indicated in step 202, which thus discards detail. One way to reduce the size is to merely shrink the image, e.g., to 32×32 pixels. Color can also be removed from image resulting in a grayscale, as indicated in step 204, to further simplify the number of computations.

Now the DCT is computed as indicated in step 206. The DCT separates the image into a collection of frequencies and scalars in a 32×32 matrix. For the purposes of the perceptual hash, the DCT can further be reduced by keeping only the top left 8×8 portion of the matrix (as indicated in step 208), which constitute the lowest frequencies in the picture.

Next, the average value of the 8×8 matrix is computed (as indicated in step 210), excluding the first term as this coefficient can be significantly different from the other values and will throw off the average. This excludes completely flat image information (i.e. solid colors) from being included in the hash description. The DCT matrix values for each frame are next reduced to binary values as indicated in step 212. Each of the 64 hash bits may be set to 0 or 1 depending on whether each of the values is above or below the average value just computed. The result provides a rough, relative scale of the frequencies to the mean. The result will not vary as long as the overall structure of the image remains the same and thus provides an ability to identify highly similar frames. Next, a hash value is computed for each frame as indicated in step 214. For example, the 64 bits may be translated following a consistent order into a 64-bit integer.

Returning to the overall process of aligning textless frames with a film of FIG. 1, after operation 108, the method 100 proceeds to operation 110 and the analyzed frame data is compared between the texted frames in the film and the textless frames to determine matching frames. The comparison may depend upon what type of frame data was used as a basis for the analysis and the method of frame data analysis used at operation 108. For example, in the case of perceptual image hashing, the hash values for the texted frames in the original texted version of the film are compared to the hash values for the textless frames in the film clips and frames with similar hash values are determined. The comparison and similarity of hash values may depend on the hash algorithm used in operation 108, as different hash values may result from different hash algorithms. For example, if the perceptual hash process 200 depicted in FIG. 2 is applied, then the comparison will depend on bit positions. In this example, in order to compare two images, one can count the number of bit positions that are different between two integers (this is referred to as the Hamming distance). A distance of zero indicates that it is likely a very similar picture (or a variation of the same picture). A distance of 5 means a few things may be different, but they are probably still close enough to be similar. Therefore, all images with a hash difference of less than 6 bits out of 64 may be considered similar and grouped together.

In one embodiment, a mask from a single texted frame or from a group of similarly texted frames in the texted version of the film, created at operation 104, may have been applied to all textless frame clips at operation 106. In this case, when frame data surrounding the masks is compared, the textless frame clip or frame with matching frame data to the single texted frame or group of texted frames may be associated with that particular texted frame or group of texted frames. This process may be repeated for each texted frame or group of similarly texted frames in the texted version of the film to locate their associated textless frame clips or frames. In another embodiment, a plurality of masks created for the texted frames in the texted version of the film, created at operation 104, may be applied to all of the textless frames. In this case, a comparison of the frame data surrounding the plurality of masks may show different associations between different textless frames and texted frames. Again, this is only feasible where there are limited titles and masks. For example, the comparison may be feasible where the masks cover less than 30-40% of the frame, allowing for comparison of at least 60% of the surrounding frame data.

After operation 110, the method 100 proceeds to operation 112 and the frame locations for each textless frame in the film clip or clips are determined based on the frame locations of texted frames from the original film with similar frame data. The texted frames from the original film may have frame numbers or time coding information that indicates the frame location within the film. Thus, by aligning the textless frames with the numbered or time coded texted frames from the original film, the correct position of the textless frames within the original film can be determined.

After operation 112, the method 100 proceeds to either operation 114 or operation 116. If the method 100 proceeds to operation 114, an EDL is generated based on the established frame data from operation 112. An EDL is used during post-production and contains an ordered list of frame information, such as reel and timecode data, representing where each frame, sequence of frames, or scenes can be obtained to conform to a particular edit or version of the film. Establishing an EDL with information for titling sequences may be important for localization. Further, an EDL may be of particular importance for a textless master copy of a film in order to quickly assess where to insert title sequences. After operation 114, the method 100 may proceed to operation 116 and a textless master copy is also created in addition to the EDL.

The method 100 may also proceed directly from operation 112 to operation 116 to create a textless master copy. The textless titles may be easily aligned with the appropriate texted frames in the texted version of the film based on the determined frame locations in operation 112. The textless frames may replace the texted frames, creating a clean copy of the film with no text, or a textless master copy. The textless master copy may then be stored and used for localization in numerous countries. After operation 116, the method 100 may proceed to operation 114 and an EDL may also be generated in addition to the textless master copy.

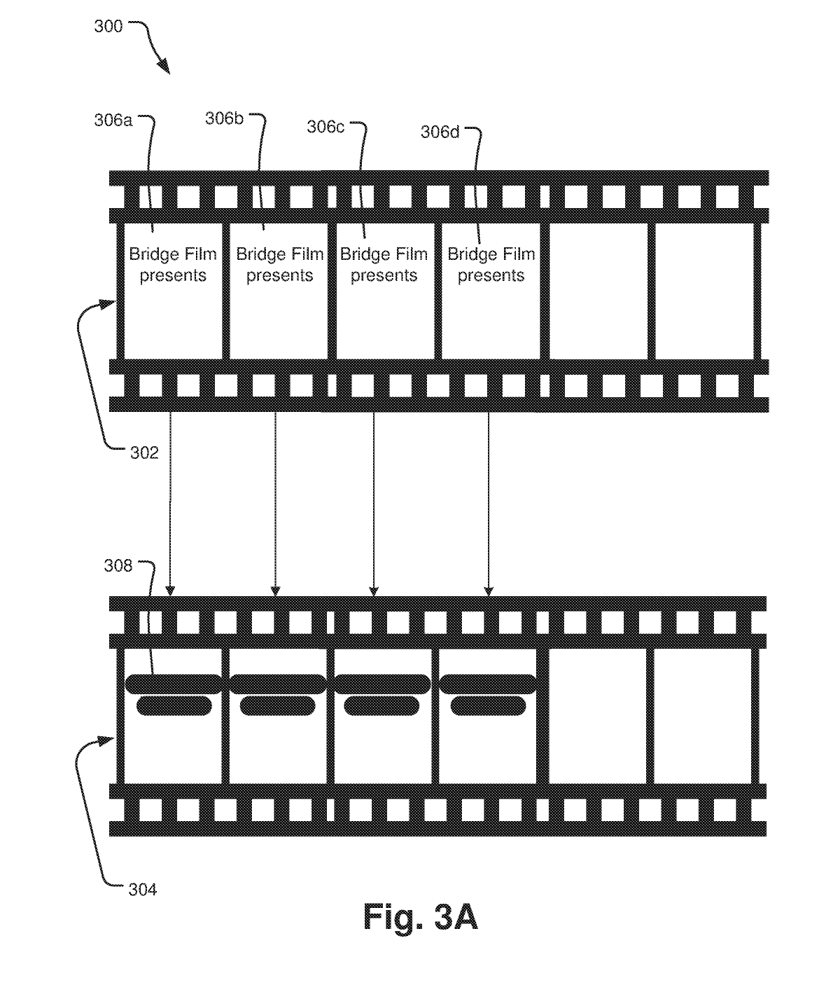

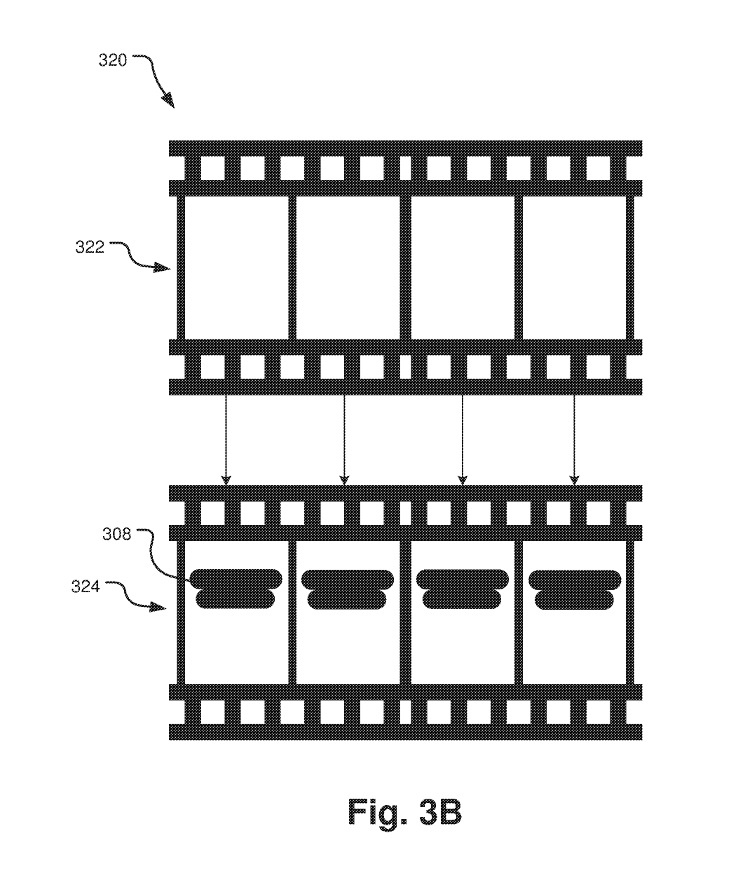

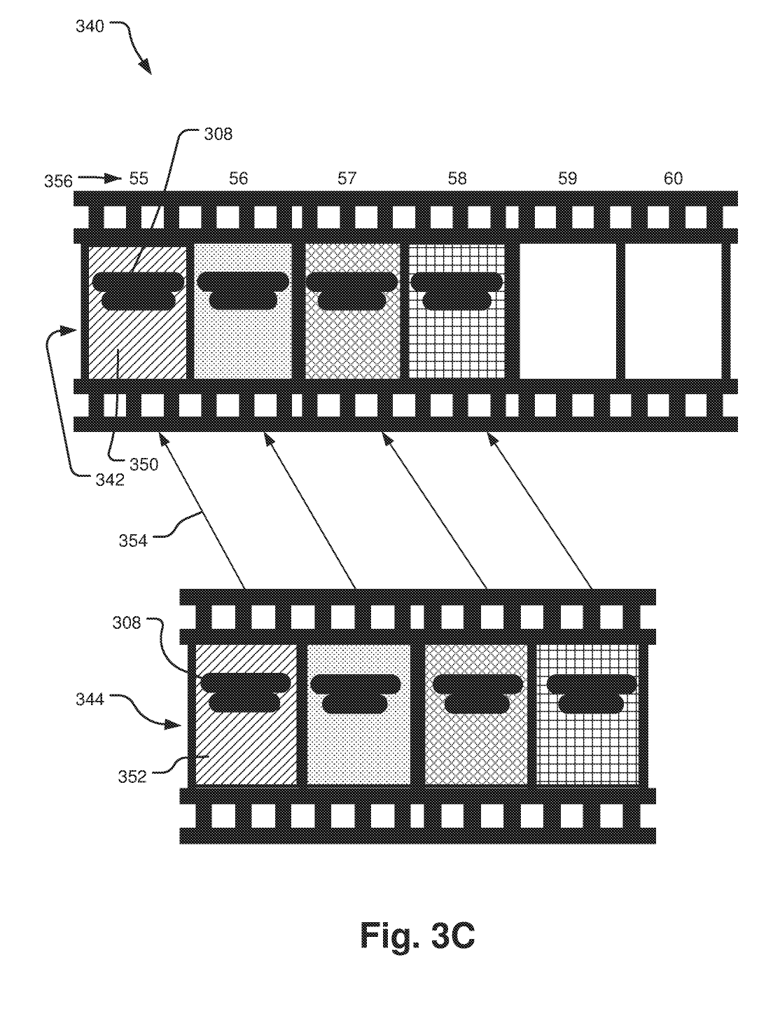

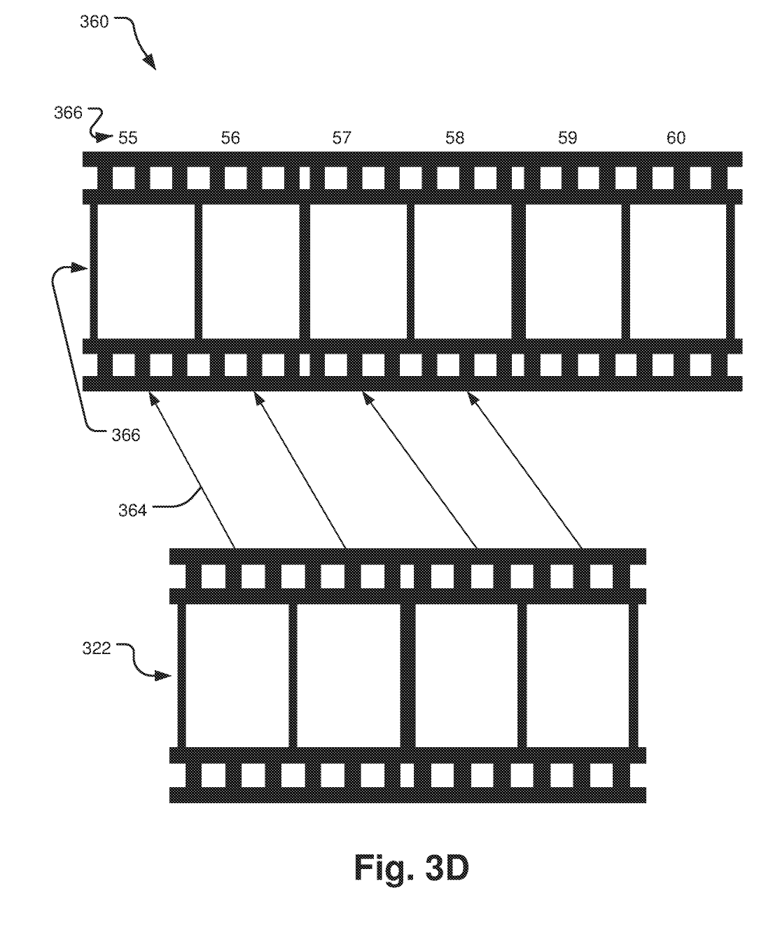

FIGS. 3A-D are picture diagrams illustrating a method of generating a textless master copy based on a comparison of textless frame data in a texted version of a film and textless film clips. It should be noted that the film strips and titled frames depicted in FIGS. 3A-D are merely representative. An actual title sequence is typically located across a large number of frames. For example, a title may exist on 120 sequential frames, lasting 5 seconds on the screen (where the frame rate is 24 frames/second). However, for ease of presentation and description, the film strips are depicted with only a few frames.

FIG. 3A shows a method 300 of masking titles in an original texted version of a film. FIG. 3A shows a portion of an original version of a film 302 with a title located at multiple frames along the film strip 306a-d. The titles in the titled frames 306a-d are masked 308, which creates a masked titles version of the film 304.

FIG. 3B shows a method 320 of masking the same areas in a film clip containing textless frames as were masked in the film of FIG. 3A. FIG. 3B shows a textless film clip 322. The same mask 308 that was applied to the text in the texted version of the film in FIG. 3B is applied to the textless film clip, which creates a masked textless film clip 324. The mask 308 is imposed at the same location for all frames.

FIG. 3C shows a method 340 of analyzing and comparing frame data surrounding the masks for the film of FIG. 3A and the film clip of FIG. 3B in order to determine the frame position of the textless frames in the film clip with respect to the texted version. After the titles are masked in methods 300 and 320, frame data analysis may be performed on the remaining data surrounding the masks. In FIG. 3C, unique frame level data 350, 352 for each frame is represented by a unique pattern for each frame. For example, the unique patterns may represent hash values created by performing perceptual hashing on the images surrounding the masks. For example, perceptual hashing may be applied to the image area 350 surrounding the masks 308 in the original texted version of the film to produce hash values for the image area 350 for each titled frame, creating a masked version of the film 342 with corresponding hash values for each frame.

Perceptual hashing may also be applied to the image area 352 surrounding the masks 308 in the textless film clip to produce hash values for each textless frame, creating a masked version of the textless film clip 344 with corresponding hash values for each frame. It is contemplated that each frame may have a unique hash depending on the size of the mask and the images surrounding the mask. Each unique hash produced for each frame in the textless film clip 344 is compared the unique hash values produced for each texted frame in the film 342 to identify matching values and thus a likely hood that the textless frame is the same frame as a texted frame. If a series of frames from a textless clip align in sequence with a series of frames on the texted version based upon a high correlation of hash values of the frames, it is highly likely that the textless clip is the same as the frames of the texted version in that area. This step in method 340 is shown in FIG. 3C by arrows 354 that match up frames with the same patterns, representing frames with highly similar hash values. While a comparison of hash values is described in detail above, other frame data and analysis may be used in the same manner to align the frames.

Once the frames in the textless film clip 344 are aligned with similar or matching frames in the texted version of the film 342, the frame position or time stamp of each frame in the textless film clip 344 with respect to the texted version of the film 342 may be determined. As shown in FIG. 3C, the film 342 has frame numbers 356. The frame numbers 356 shown are 55-60. The frames in the textless film clip 344 match with frames 55, 56, 57, and 58 in the texted version of the film 342. These frame numbers in the film 342 are therefore associated with the respective matching frames in the textless film clip 344.

FIG. 3D shows a method 360 of creating a textless master using textless film clips. The frames in the textless film clip 322 may be aligned and inserted 364 into the film 362 to create a textless master copy of the film 362. As shown, the master copy 362 also has frame numbers 366. The frames in the textless film clip 322 are aligned 364 with frames 55, 56, 57 and 58 and inserted 364 in the master copy 362. The frames in the textless film clip 322 may be inserted at these frames to replace the texted frames in the master copy 362 and thereby create a textless master copy 362 of the film.

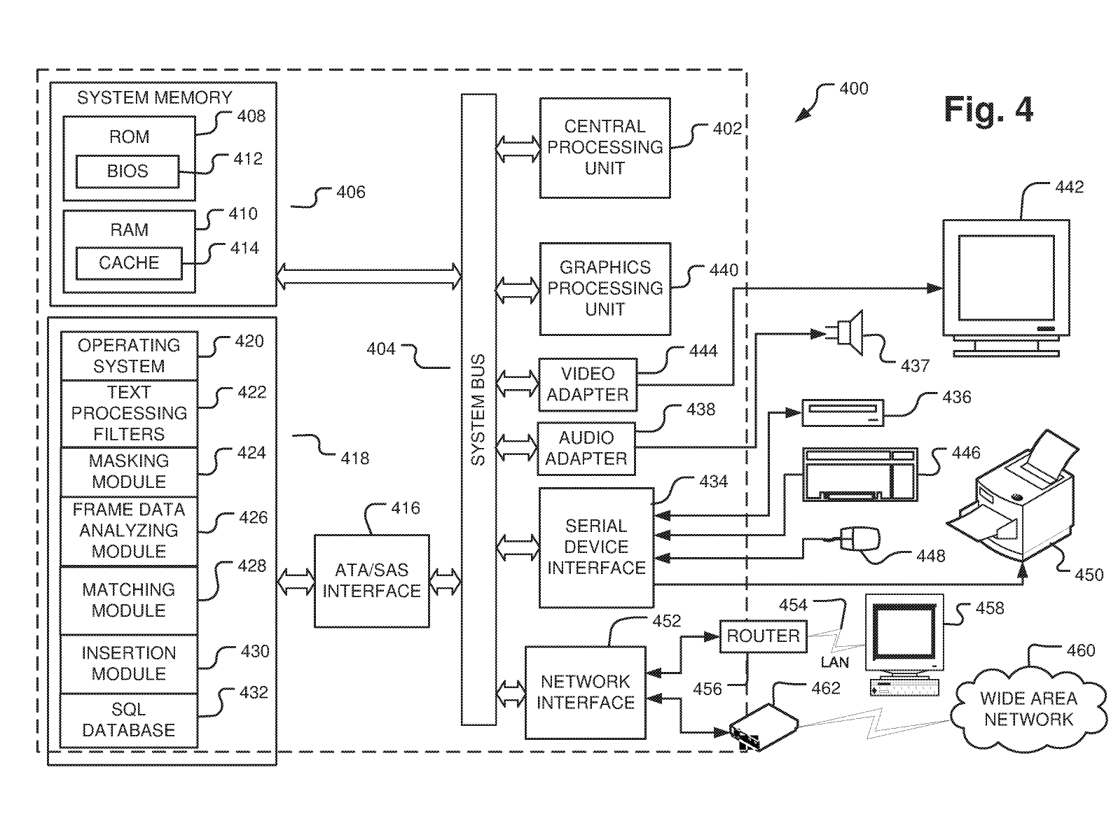

An exemplary computer-implemented media processing and alignment system 400 for implementing the frame aligning processes above is depicted in FIG. 4. The frame alignment system 400 may be embodied in a specifically configured, high-performance computing system including a cluster of computing devices in order to provide a desired level of computing power and processing speed. Alternatively, the process described herein could be implemented on a computer server, a mainframe computer, a distributed computer, a personal computer (PC), a workstation connected to a central computer or server, a notebook or portable computer, a tablet PC, a smart phone device, an Internet appliance, or other computer devices, or combinations thereof, with internal processing and memory components as well as interface components for connection with external input, output, storage, network, and other types of peripheral devices. Internal components of the frame alignment system 400 in FIG. 4 are shown within the dashed line and external components are shown outside of the dashed line. Components that may be internal or external are shown straddling the dashed line.

In any embodiment or component of the system described herein, the frame alignment system 400 includes one or more processors 402 and a system memory 406 connected by a system bus 404 that also operatively couples various system components. There may be one or more processors 402, e.g., a single central processing unit (CPU), or a plurality of processing units, commonly referred to as a parallel processing environment (for example, a dual-core, quad-core, or other multi-core processing device). In addition to the CPU, the frame alignment system 400 may also include one or more graphics processing units (GPU) 440. A GPU 440 is specifically designed for rendering video and graphics for output on a monitor. A GPU 440 may also be helpful for handling video processing functions even without outputting an image to a monitor. By using separate processors for system and graphics processing, computers are able to handle video and graphic-intensive applications more efficiently. As noted, the system may link a number of processors together from different machines in a distributed fashion in order to provide the necessary processing power or data storage capacity and access.

The system bus 404 may be any of several types of bus structures including a memory bus or memory controller, a peripheral bus, a switched-fabric, point-to-point connection, and a local bus using any of a variety of bus architectures. The system memory 406 includes read only memory (ROM) 408 and random access memory (RAM) 410. A basic input/output system (BIOS) 412, containing the basic routines that help to transfer information between elements within the computer system 400, such as during start-up, is stored in ROM 408. A cache 414 may be set aside in RAM 410 to provide a high speed memory store for frequently accessed data.

A data storage device 418 for nonvolatile storage of applications, files, and data may be connected with the system bus 404 via a device attachment interface 416, e.g., a Small Computer System Interface (SCSI), a Serial Attached SCSI (SAS) interface, or a Serial AT Attachment (SATA) interface, to provide read and write access to the data storage device 418 initiated by other components or applications within the frame alignment system 400. The data storage device 418 may be in the form of a hard disk drive or a solid state memory drive or any other memory system. A number of program modules and other data may be stored on the data storage device 418, including an operating system 420, one or more application programs, and data files. In an exemplary implementation, the data storage device 418 may store various text processing filters 422, a masking module 424, a frame data analyzing module 426, a matching module 428, an insertion module 430, as well as the media files being processed and any other programs, functions, filters, and algorithms necessary to implement the frame alignment procedures described herein. The data storage device 418 may also host a database 432 (e.g., a NoSQL database) for storage of video frame time stamps, bounding box and masking parameters, frame data analysis algorithms, hashing algorithms, media meta data, and other relational data necessary to perform the media processing and alignment procedures described herein. Note that the data storage device 418 may be either an internal component or an external component of the computer system 400 as indicated by the hard disk drive 418 straddling the dashed line in FIG. 4.

In some configurations, the frame alignment system 400 may include both an internal data storage device 418 and one or more external data storage devices 436, for example, a CD-ROM/DVD drive, a hard disk drive, a solid state memory drive, a magnetic disk drive, a tape storage system, and/or other storage system or devices. The external storage devices 436 may be connected with the system bus 404 via a serial device interface 434, for example, a universal serial bus (USB) interface, a SCSI interface, a SAS interface, a SATA interface, or other wired or wireless connection (e.g., Ethernet, Bluetooth, 802.11, etc.) to provide read and write access to the external storage devices 436 initiated by other components or applications within the frame alignment system 400. The external storage device 436 may accept associated computer-readable media to provide input, output, and nonvolatile storage of computer-readable instructions, data structures, program modules, and other data for the frame alignment system 400.

A display device 442, e.g., a monitor, a television, or a projector, or other type of presentation device may also be connected to the system bus 404 via an interface, such as a video adapter 440 or video card. Similarly, audio devices, for example, external speakers, headphones, or a microphone (not shown), may be connected to the system bus 404 through an audio card or other audio interface 438 for presenting audio associated with the media files.

In addition to the display device 442 and audio device 447, the frame alignment system 400 may include other peripheral input and output devices, which are often connected to the processor 402 and memory 406 through the serial device interface 444 that is coupled to the system bus 406. Input and output devices may also or alternately be connected with the system bus 404 by other interfaces, for example, a universal serial bus (USB), an IEEE 1494 interface (“Firewire”), a parallel port, or a game port. A user may enter commands and information into the frame alignment system 400 through various input devices including, for example, a keyboard 446 and pointing device 448, for example, a computer mouse. Other input devices (not shown) may include, for example, a joystick, a game pad, a tablet, a touch screen device, a satellite dish, a scanner, a facsimile machine, a microphone, a digital camera, and a digital video camera.

Output devices may include a printer 450. Other output devices (not shown) may include, for example, a plotter, a photocopier, a photo printer, a facsimile machine, and a printing press. In some implementations, several of these input and output devices may be combined into single devices, for example, a printer/scanner/fax/photocopier. It should also be appreciated that other types of computer-readable media and associated drives for storing data, for example, magnetic cassettes or flash memory drives, may be accessed by the computer system 400 via the serial port interface 444 (e.g., USB) or similar port interface. In some implementations, an audio device such as a loudspeaker may be connected via the serial device interface 434 rather than through a separate audio interface.

The frame alignment system 400 may operate in a networked environment using logical connections through a network interface 452 coupled with the system bus 404 to communicate with one or more remote devices. The logical connections depicted in FIG. 4 include a local-area network (LAN) 454 and a wide-area network (WAN) 460. Such networking environments are commonplace in home networks, office networks, enterprise-wide computer networks, and intranets. These logical connections may be achieved by a communication device coupled to or integral with the frame alignment system 400. As depicted in FIG. 4, the LAN 454 may use a router 456 or hub, either wired or wireless, internal or external, to connect with remote devices, e.g., a remote computer 458, similarly connected on the LAN 454. The remote computer 458 may be another personal computer, a server, a client, a peer device, or other common network node, and typically includes many or all of the elements described above relative to the computer system 400.

To connect with a WAN 460, the frame alignment system 400 typically includes a modem 462 for establishing communications over the WAN 460. Typically the WAN 460 may be the Internet. However, in some instances the WAN 460 may be a large private network spread among multiple locations, or a virtual private network (VPN). The modem 462 may be a telephone modem, a high speed modem (e.g., a digital subscriber line (DSL) modem), a cable modem, or similar type of communications device. The modem 462, which may be internal or external, is connected to the system bus 418 via the network interface 452. In alternate embodiments the modem 462 may be connected via the serial port interface 444. It should be appreciated that the network connections shown are exemplary and other means of and communications devices for establishing a network communications link between the computer system and other devices or networks may be used.

The technology described herein may be implemented as logical operations and/or modules in one or more systems. The logical operations may be implemented as a sequence of processor-implemented steps directed by software programs executing in one or more computer systems and as interconnected machine or circuit modules within one or more computer systems, or as a combination of both. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

The above specification, examples and data provide a complete description of the structure and use of exemplary embodiments of the invention as defined in the claims. Although various embodiments of the claimed invention have been described above with a certain degree of particularity, or with reference to one or more individual embodiments, those skilled in the art could make numerous alterations to the disclosed embodiments without departing from the spirit or scope of the claimed invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A computer-implemented media frame alignment system comprising
a storage device configured to ingest and store one or more media files thereon; and
one or more processors configured with instructions to
receive a texted version of a multimedia production and a textless media clip associated with the texted version of the multimedia production, wherein the texted version of the multimedia production comprises one or more texted frames and the textless media clip comprises one or more textless frames;
mask text in the one or more texted frames;
mask a same area in the one or more textless frames as the text in the one or more texted frames;
analyze frame data surrounding the masks;
compare the analyzed frame data between the one or more texted frames and the one or more textless frames to determine frames with similar frame data; and
align the one or more textless frames with the one or more texted frames based on frames with similar frame data.

2. The computer-implemented media frame alignment system of claim 1, wherein the one or more processors are further configured with instructions to determine one or more frame locations for the one or more textless frames based on the alignment of the one or more textless frames with the one or more texted frames, wherein the texted frames include at least one of frame numbering or timing information.

3. The computer-implemented media frame alignment system of claim 2, wherein the one or more processors are further configured with instructions to generate at least one of an edit decision list (EDL) or a textless master copy based on the determined one or more frame locations for the one or more textless frames.

4. The computer-implemented media frame alignment system of claim 3, wherein the one or more processors are further configured with instructions to insert the one or more textless frames into a copy of the multimedia production based on the determined one or more frame locations to generate the textless master copy.

5. The computer-implemented media frame alignment system of claim 3, wherein the one or more processors are further configured to store at least one of the edit decision list (EDL) or textless master copy on the storage device.

6. The computer-implemented media frame alignment system of claim 1, wherein the instructions to analyze frame data surrounding the masks comprises instructions to perform a perceptual hash algorithm on the image areas surrounding the masks to produce a hash value for each frame.

7. The computer-implemented media frame alignment system of claim 6, wherein the instructions to compare the analyzed frame data comprises instructions to compare hash values.

8. The computer-implemented media frame alignment system of claim 7, wherein the instructions to compare hash values comprises instructions to compare bit positions and determine a number of bit positions that are different.

9. A method implemented on a computer system for aligning media frames, wherein one or more processors in the computer system is particularly configured to perform a number of processing steps comprising
receiving a texted version of a multimedia production and a textless media clip associated with the texted version of the multimedia production, wherein the texted version of the multimedia production comprises one or more texted frames and the textless media clip comprises one or more textless frames;
masking text in the one or more texted frames;
masking a same area as the text in the one or more texted frames in the one or more textless frames;
analyzing frame data surrounding the masks;
comparing the analyzed frame data between the one or more texted frames and the one or more textless frames to determine frames with similar frame data; and
aligning the one or more textless frames with the one or more texted frames based on frames with similar frame data.

10. The method of claim 9, comprising a further step of determining one or more frame locations for the one or more textless frames based on the alignment of the one or more textless frames with the one or more texted frames, wherein the texted frames include at least one of frame numbering or timing information.

11. The method of claim 10, comprising a further step of generating at least one of an edit decision list (EDL) or a textless master copy based on the determined one or more frame locations for the one or more textless frames.

12. The method of claim 11, comprising a further step of inserting the one or more textless frames into a copy of the multimedia production based on the determined one or more frame locations to generate the textless master copy.

13. The method of claim 11, comprising a further step of storing at least one of the edit decision list (EDL) or textless master copy on a storage device communicatively coupled to the one or more processors in the computer system.

14. The method of claim 9, wherein the analyzing step comprises performing a perceptual hash algorithm on the images surrounding the masks to produce a hash value for each frame.

15. The method of claim 14, wherein the comparing step comprises comparing hash values.

16. The method of claim 15, wherein comparing hash values comprises comparing bit positions and determining a number of bit positions that are different.

17. A non-transitory computer readable storage medium containing instructions for instantiating a special purpose computer to align media frames, wherein the instructions implement a computer process comprising the steps of
receiving a texted version of a multimedia production and a textless media clip associated with the texted version of the multimedia production, wherein the texted version of the multimedia production comprises one or more texted frames and the textless media clip comprises one or more textless frames;
masking text in the one or more texted frames;
masking a same area as the text in the one or more texted frames in the one or more textless frames;
analyzing frame data surrounding the masks;
comparing the analyzed frame data between the one or more texted frames and the one or more textless frames to determine frames with similar frame data; and
aligning the one or more textless frames with the one or more texted frames based on frames with similar frame data.

18. The non-transitory computer readable storage medium of claim 17, wherein the instructions implement a further process step comprising determining one or more frame locations for the one or more textless frames based on the alignment of the one or more textless frames with the one or more texted frames, wherein the texted frames include at least one of frame numbering or timing information.

19. The non-transitory computer readable storage medium of claim 18, wherein the instructions implement a further process step comprising generating at least one of an edit decision list (EDL) or a textless master copy based on the determined one or more frame locations for the one or more textless frames.

20. The non-transitory computer readable storage medium of claim 19, wherein the instructions implement a further process step comprising inserting the one or more textless frames into a copy of the multimedia production based on the determined one or more frame locations to generate the textless master copy.

21. The non-transitory computer readable storage medium of claim 19, wherein the instructions implement a further process step comprising storing at least one of the edit decision list (EDL) or textless master copy in the non-transitory computer readable storage medium.

22. The non-transitory computer readable storage medium of claim 17, wherein the analyzing step comprises performing a perceptual hash algorithm on the images surrounding the masks to produce a hash value for each frame.

23. The non-transitory computer readable storage medium of claim 22, wherein the comparing step comprises comparing hash values.

24. The non-transitory computer readable storage medium of claim 23, wherein comparing hash values comprises comparing bit positions and determining a number of bit positions that are different.
